(19) United States
(12) Patent Application Publication
(10) Pub. No.: US 2016/0221014 A1
(43) Pub. Date: Aug. 4, 2016

(54) SIMPLIFIED COLD SPRAY NOZZLE AND GUN

(71) Applicant: UNITED TECHNOLOGIES CORPORATION, Hartford, CT (US)

(72) Inventors: Aaron T. NARDI, East Granby, CT (US); Michael A. KLECKA, Coventry, CT (US); Justin R. HAWKES, Marlborough, CT (US); Thomas H. LAWTON, Wethersfield, CT (US)

(73) Assignee: United Technologies Corporation, Hartford, CT (US)

(21) Appl. No.: 14/917,358

(22) PCT Filed: Sep. 23, 2014
(86) PCT No.: PCT/US2014/056936

§ 371 Date: Mar. 8, 2016

Related U.S. Application Data
(60) Provisional application No. 61/882,291, filed on Sep. 25, 2013.

(51) Int. Cl. B05B 7/16; B05B 7/14

(52) U.S. Cl. CPC B05B 7/1626; B05B 7/1486

(57) ABSTRACT

A cold spray nozzle assembly includes a conduit for carrying at least one of a heated gas and a powder; a nozzle; and a compression tube fitting connecting the nozzle to the conduit.

### BACKGROUND

The disclosure relates to a cold spray nozzle assembly used in a cold spray system that deposits a powder material onto a substrate.

Cold spray systems range in capability from high temperature, high pressure systems to lower pressure and temperature systems. In all cases it is crucial to have a nozzle with the correct geometry capable of withstanding the temperatures and pressures used in the device. These nozzles are designed to fit the equipment using special flanges, tapered sleeves, or the like. Further, the guns to which the nozzles are affixed are typically designed as pressure vessels generally for the purpose of mixing and porting the gases and powders to the nozzle.

Known assemblies for connecting nozzles to cold spray guns are complex and expensive. In addition to the cost of components for connecting the nozzle to the gun, these assemblies can be difficult or impossible to fit into small spaces, which limit their use.

Based upon the foregoing, the need exists for a simpler, more cost effective and compact structure for connecting the nozzle to a cold spray gun.

### SUMMARY OF THE DISCLOSURE

The present disclosure provides a cold spray nozzle and gun which simplifies the connection of the nozzle to the gun, and helps to provide a much more compact nozzle assembly, thereby allowing a cold spray gun to be used to apply powdered materials to substrates in locations which would be difficult if not impossible to reach using conventional devices.

In accordance with the present disclosure, a cold spray nozzle assembly is provided having a conduit for carrying at least one of a heated gas and a powder; a nozzle; and a compression tube fitting connecting the nozzle to the conduit.

One compression tube fitting can include a receiving fitting attached from the conduit and receiving an end of the nozzle, a compression ring and a compression nut, the compression ring being mounted between the receiving fitting and the compression nut and surrounding the nozzle, whereby tightening the compression nut onto the receiving fitting compresses the compression ring onto the nozzle.

A step can be provided on an outer diameter of the nozzle, the step interacting with the receiving fitting to properly locate the nozzle to the receiving fitting.

The nozzle can be provided with a notch on an outer diameter which is aligned with the compression ring whereby the compression ring engages the notch when the compression nut is tightened relative to the receiving fitting.

The receiving fitting can be threaded to the conduit.

The nozzle can have an inlet and an outlet end and a throat section, and an inlet for feeding the powder to the nozzle can be provided in the form of a tube or other conduit for carrying the powder, wherein the tube extends along an axis of the nozzle from the inlet end and through the throat section of the nozzle.

The inlet end of the nozzle can be provided with rounded edges.

In accordance with a further aspect of the present disclosure, a cold spray nozzle assembly is provided which can include a nozzle having an inlet end, an outlet end and a throat section between the inlet end and the outlet end, a conduit for carrying a heated gas to the inlet end of the nozzle, an inlet for feeding powder to the nozzle, wherein the inlet is a tube for carrying the powder, the tube extending along an axis of the nozzle from the inlet end, and through the throat section.

This aspect of the invention can be combined with compression tube fittings as discussed above, for example connecting the nozzle to the conduit.

In further accordance with the disclosure, a cold spray gun is provided having a conduit communicated with a source of gas and a source of powder; a nozzle; and a compression tube fitting connecting the nozzle to the conduit.

The cold spray gun can have a plurality of conduits supplying gas and powder as well as thermocouple access upstream of the nozzle. Because of this arrangement, addition of sensors, multiple powder feeds, and changing the distance between powder injection points and the nozzle can be accomplished with common hardware. This simplicity and reduced cost hardware also enables the fabrication of multiple gun-nozzle assemblies to reduce contamination issues when changing powders in cold spray systems.

The details of one or more embodiments are set forth in the accompanying drawings and the description below. Other features, objects, and advantages will be apparent from the description and drawings, and from the claims.

### BRIEF DESCRIPTION OF THE DRAWINGS

A detailed description of embodiments of the present disclosure appears below, with reference to the attached drawings, wherein:

FIG. 1 illustrates a compression tube fitting connecting a nozzle to a conduit in accordance with the present disclosure.

FIGS. 2-4 illustrate different configurations of cold spray guns incorporating the compression tube fittings in accordance with the present disclosure;

FIGS. 5 and 5a illustrate an embodiment of a nozzle in accordance with the present disclosure;

FIG. 6 illustrates a further embodiment of a nozzle according to the disclosure;

FIG. 7 illustrates a further embodiment of a nozzle in accordance with the present disclosure;

FIG. 8 illustrates a further aspect of the disclosure relating to a four way compression tube fitting;

FIG. 9 illustrates one configuration according to the disclosure having a four way compression tube fitting connecting various components to a tube mounted to a robot for spraying powder; and

FIG. 10 shows an alternate configuration of a system similar to that illustrated in FIG. 9.

Like reference numbers and designations in the various drawings indicate like elements.

### DETAILED DESCRIPTION

The disclosure relates to a cold spray nozzle assembly and to a cold spray gun including the nozzle assembly, wherein the assembly has more compact structure which allows for reduced cost and increased versatility in use to apply powders to substrates as desired.

Cold spray systems range in capability from high temperature, high pressure systems to lower pressure and temperature systems. Typical operating ranges for such systems are as follows: 10-50 bar operating pressures with ambient to 1200° C. gas temperatures. In all cases, it is critical to have a nozzle with the correct geometry, wherein the nozzle is capable of operating in the temperatures and pressures used in the device, and with a design capable of accelerating the gas and powdered materials to the velocities critical for consolidation. Known nozzles are designed to be connected to pressure vessels, often called the “gun”, using special flanges, tapered sleeves or threads. Further, the pressure vessels are generally designed to mix and port the gases and powders to the nozzle.

The present disclosure provides a much more compact assembly as compared to known devices, and does so by connecting the nozzle to a flow conduit of the cold spray nozzle device using a compression tube fitting, which allows for a tight seal with the nozzle through commonly available temperature and pressure rated fittings and ferrules. Construction of the gun can then be accomplished using standard tubing and fittings capable of withstanding the required temperatures and pressures.

Configurations of this type can be constructed resulting in minimized overall size, at a minimum cost and with great flexibility in system design and monitoring. One example of the versatility produced with such assemblies is that a cold spray configuration can be assembled for use in applying powder coatings to internal diameters wherein the internal diameter coatings can be applied to internal diameters as small as three inches. In a second example fittings can be assembled allowing powder to be introduced several inches (4 to 12 inches for example) from the nozzle with multiple thermocouples through that length monitoring gas temperature history from the point of powder injection to the nozzle.

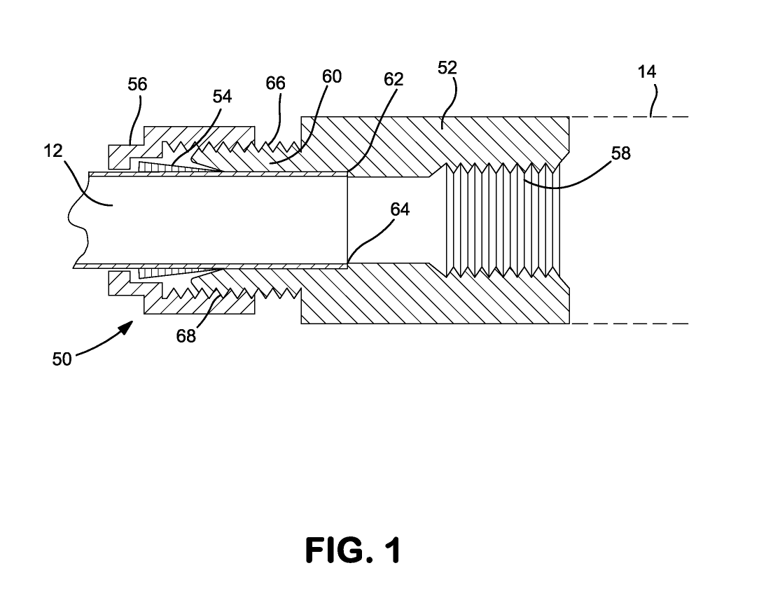

FIG. 1 illustrates a compression tube fitting 50 for connecting a nozzle to a conduit in accordance with the present disclosure. This nozzle can have a straight outer diameter equivalent to the tube diameter for the ferrule and nut of the compression tube fitting being used. In high pressure applications, this nozzle outer diameter can have a reduced diameter notch at the thinnest end of the ferrule in which the ferrule can deform and create a mechanical interlock. In a third example this outer diameter can be stepped larger at the thin end of the ferrule for mechanical interlocking followed by reaming of the mating compression fitting to match the stepped diameter.

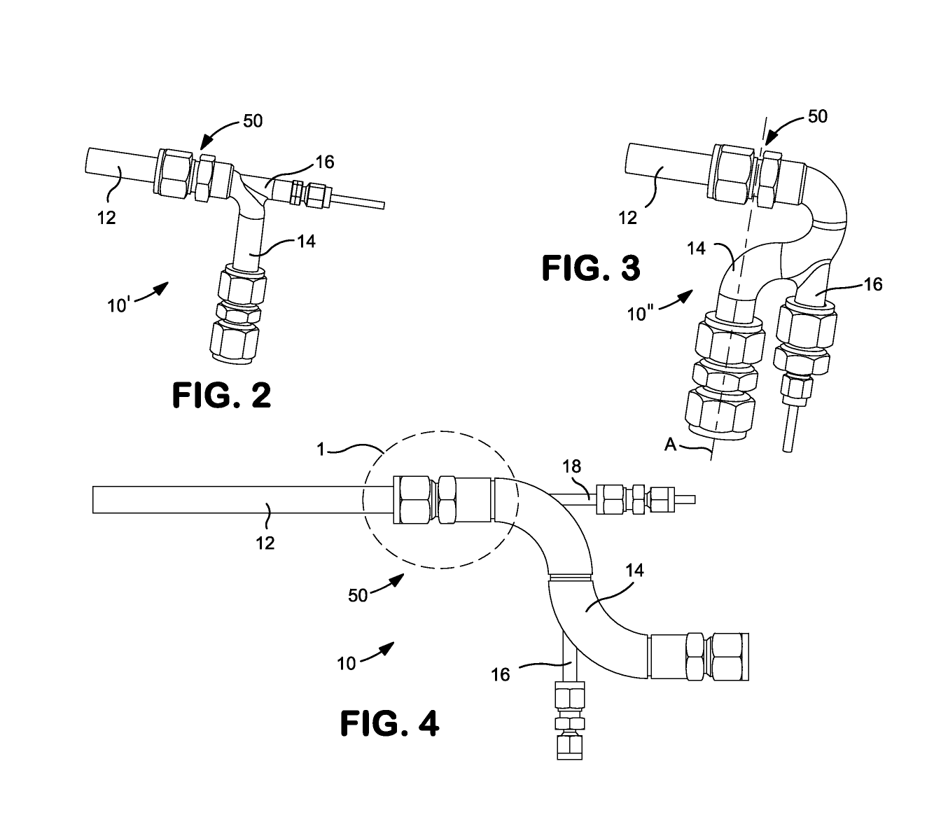

FIGS. 2-4 illustrate cold spray guns or systems incorporating the cold spray nozzle assembly in accordance with the present disclosure. Referring to FIG. 4, a cold spray system 10 is shown having a nozzle 12, a conduit 14 for carrying hot gas, and a feed 16 for powder. FIG. 4 also shows a connection 18 for a thermocouple to monitor temperature within nozzle 12 as desired. For maximum flexibility, ports 16 and 18 can additionally be reversed such that 18 is for powder and 16 is used for a thermocouple.

In use, hot gas is fed through conduit 14 to nozzle 12, and powder is fed through the flow of hot gas in conduit 14 such that the hot gas and powder are propelled through the nozzle 12 for application to a substrate as desired.

In an apparatus such as that described in the present disclosure, powder can be heated by being carried along a conduit along with a hot gas, and the extent to which the powder is heated can be controlled by adjusting where with respect to the flow of hot gas and nozzle the powder is injected. The longer the powder is carried by the hot gas prior to being sprayed through the nozzle, the more heat is transferred to the powder, which can be desired or undesirable, depending upon the application and the powder being used.

FIGS. 2 and 3 show similar configurations of systems 10′ 10″ with nozzle 12, hot gas conduit 14 and powder feed 16 connected in different positions as compared to FIG. 4.

FIG. 4 shows compression tube fitting 50 for joining and sealing nozzle 12 to conduit 14.

Referring back to FIG. 1, a cross-sectional view of a compression tube fitting 50 is provided, and shows an end of nozzle 12 held in a receiving fitting 52 and secured there by a compression ring or ferrule 54 which is acted upon by a compression nut 56 to securely hold nozzle 12 in place with respect to receiving fitting 52 as desired. Receiving fitting 52 in this embodiment has internal threads 58 which can be used to secure fitting 52 to a conduit such as hot gas conduit 14. Receiving fitting 52 can be provided having various other structures for connection to conduits as desired, including external threading and the like.

As shown in FIG. 1, receiving fitting 52 has a neck portion 60 extending away from threads 58 for receiving nozzle 12. Neck portion 60 can have an inside diameter sized to closely fit the outside diameter of nozzle 12, and can also be provided with a step 62 on the inside diameter as shown in FIG. 1. Step 62 engages the edge 64 of nozzle 12 and thereby holds nozzle 12 in the proper axial position with respect to receiving fitting 52. Neck portion 60 also can have outer threads 66 which can be used to engage with compression nut 56 so that compression nut 56 can be tightened with respect to receiving fitting 52.

Compression ring 54 is shown positioned for axial compression between compression nut 56 and receiving fitting 52, and such compression causes compression ring 54 to mechanically secure nozzle 12 relative to receiving fitting 52 (and conduit 14 to which fitting 52 would be connected), and also to seal nozzle 12 in this position.

Compression nut 56 has internal threads 68 to interact with outer threads 66 of neck portion 60. It should be appreciated that the orientation of threads as shown in the embodiment of FIG. 1 could be reversed under various different circumstances to produce the same structural connection, well within the broad scope of the present disclosure.

Simplifying the structure in accordance with the present disclosure greatly reduces the stress on the nozzle and also orients most forces in the assembly to be compressive. The outside diameter complexity of the nozzle is also greatly reduced, allowing for reduced cost nozzles made from lower strength materials. In comparison, other attachment techniques require threading of the nozzle material, flanges machined into the nozzle with special high temperature seals, or gas type tapers and special tapered flanges, all of which add significantly to the cost of the device. Brittle ceramic or cemented carbides, for instance, are difficult to machine threads or flanges where localized tensile stresses then limit the structural performance. This forces the use of larger sections of material to reduce the stress sufficiently. These materials can also be costly and difficult to machine thus raising the production costs. A simplified straight diameter of common tube size either which can be notched or stepped as described below provides a reduced size material with reduced machining requirements and minimal stress concentrations.

It should also be noted that the primary complexity of a typical cold spray gun is the nozzle assembly. The present disclosure allows for the gun to be assembled primarily from off-the-shelf compression fittings and tubings, greatly reducing costs and complexity. Further, by maintaining a ratio of tube area versus nozzle throat area preferably not less than 16:1, proper mixing of powder with hot gas is possible without the need for a special mixing chamber, while the velocity remains sufficiently low that the powder material is not deposited on turns of the tubing leading up to the nozzle. This allows for the complex mixing chambers of known guns to be completely avoided, and further allows for numerous different points of powder injection to provide for increased or decreased powder heating as may be desired.

The embodiments of FIGS. 2-4 show different arrangements of powder injection to accomplish these different levels of heating.

In the embodiment of FIG. 2, conduit 16 for feeding powder is axially aligned with nozzle 12 so that powder is introduced into the flow of hot gas substantially at, or through, the nozzle. Depending upon what is desired, the powder injection can be positioned to inject powder before or after the throat of the nozzle, as will be discussed further below.

FIG. 3 shows a configuration in accordance with the present disclosure where powder injection conduit 16 is positioned a short distance upstream from nozzle 12 to allow a portion of flow of powder some further heating in the flow of hot gas before the combination reaches nozzle 12. In this regard, FIG. 3 also shows an advantageous configuration of the present disclosure as the configuration has a relatively small dimension considered laterally with respect to axial extent (axis A) of hot gas conduit 14. Thus, a cold spray nozzle assembly and cold spray gun having the assembly as illustrated in FIG. 3 could be utilized to deposit a particulate or powdered coating on relatively small inside diameters.

In the embodiment of FIG. 4, a relatively long section of conduit 14 is positioned between powder inlet 16 and nozzle 12, and this allows for a greater amount of pre-heating before the powder is deposited.

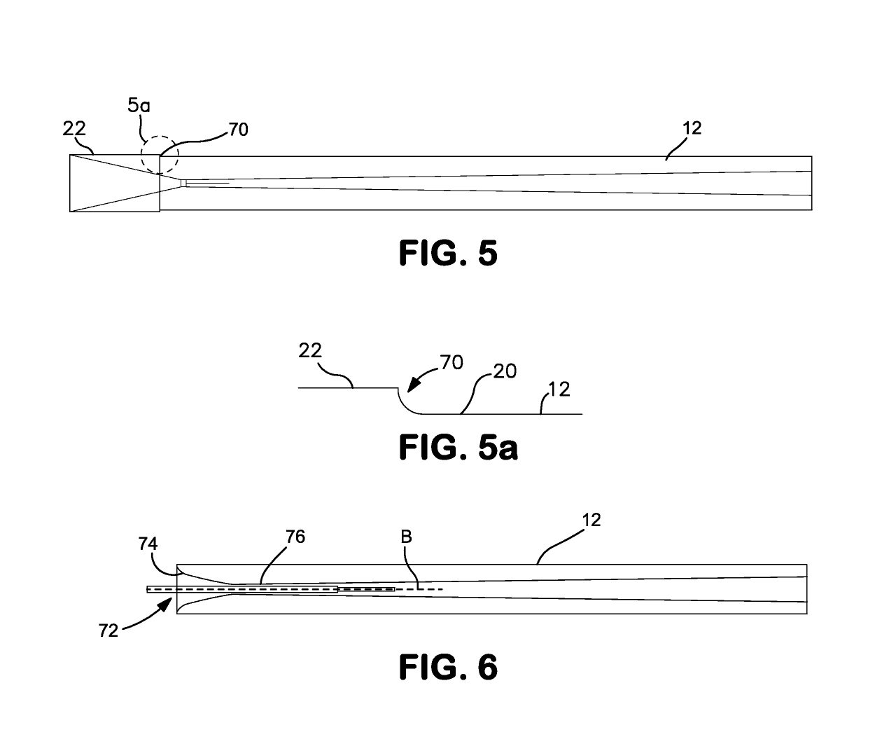

FIG. 5 is a schematic illustration of a nozzle 12 in accordance with the present disclosure having a step 70 which can be utilized to locate nozzle 12 in the compression tube fitting in accordance with the present disclosure.

FIG. 5a shows an enlarged portion of FIG. 5 to further illustrate one aspect of the configuration of step 70. As discussed in connection with FIG. 5, nozzle 12 can have one outside diameter for the normal extent of nozzle 12, and this outside diameter would be in the portion indicated in the drawings at 20. Step 70 leads to a larger outside diameter portion 22. In the illustration of FIG. 5a, the transition from section 22 is illustrated in accordance with one aspect of the disclosure, wherein a gradual curve is provided from the smaller outside diameter section 20 to the larger outside diameter section 22. This can help distribute forces in a way which preserves all components of the assembly, as the rounded transition helps to distribute forces that could damage or destroy nozzles, particularly those made of brittle material.

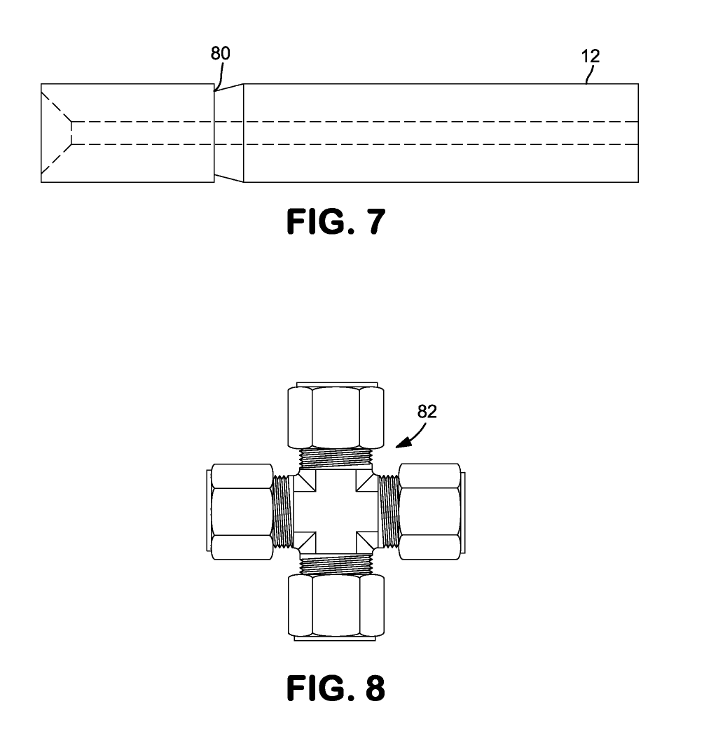

Alternatively, instead of a step 70, a notch 80 (FIG. 7) can also be formed in the outside diameter of nozzle 12. In either of these cases, the step or notch interacts with the compression tube fittings to help hold nozzle 12 axially in the desired location.

It should be appreciated that the configurations of FIGS. 5 and 7 have different properties which can be desirable in different circumstances. For example, in order to create a notch 80 as shown in FIG. 7, the wall thickness of nozzle 12 at that location must be thinned in the location of the notch, and for nozzles having an already relatively thin wall thickness, this can present issues. The configuration having a larger diameter section as illustrated in FIGS. 5 and 5a can preserve the wall thickness of the nozzle. However, this configuration can require the enlargement of components into which the nozzle is to be mounted, including, for example, components of the compression tube fitting. In some instances, no fillet or notch will be needed. This can be the case with aluminum or plastic tubes, which can deform along with the ferrule. Ferrules can be used made of graphite, particularly if the tube of the nozzle is to be made of a brittle material. The graphite can preserve the brittle material and will seal. However, in those circumstances, the connection will be more permanent than other configurations, as the graphite ferrule will permanently mechanically deform when sealed.

FIG. 6 shows a further embodiment in accordance with the present disclosure wherein the inlet end has a filleted inlet end 72. This filleted inlet end is shown with rounded edges 74 which can be helpful in positioning a powder injection conduit through the throat 76 of nozzle 12 while minimizing possibilities of the powder injection conduit from becoming jammed during assembly.

FIG. 6 also illustrates an additional aspect of the present disclosure wherein the inlet or tube for feeding powder is positioned for feeding through the throat section of the nozzle. This can reduce the amount of hot gas the powder is exposed to before being sprayed from the nozzle. Further, introduction of powder through a flow path along the axis B of the nozzle can produce a more linear and direct flow of powder through the flow expansion area of the nozzle, and this can help prevent powder from coating or sticking to inside surfaces of the nozzle.

The configuration of FIG. 6 wherein powder is fed through an inlet or tube through the throat of the nozzle is, by itself, a useful aspect of the present disclosure. This can be further facilitated by combining with the compression tube fitting aspect of the present invention.

Considering the above, it should be appreciated that the cold spray nozzle in accordance with the present disclosure and cold spray gun including same allow for great versatility in assembling the cold spray gun such that a gun can be configured to provide access to the particular substrates being coated in a particular application. Further, the assembly is simple and cost effective, and well-suited to the various operating parameters of cold spray coating.

FIGS. 8-10 illustrate particular configurations of aspects of a cold spray nozzle and gun according to the disclosure.

FIG. 8 illustrates a four-way compression tube fitting 82 which can be used to connect all components of a cold spray gun. For example, a four-way compression fitting 82 could be affixed to a tube 12 inches in length and bent such that it forms a complex curve to minimize space usage. One connection to the fitting 82 could be the gas supply, with a second being a powder feed tube, and the third being a thermocouple. The 12 inch long tube could then be connected to the nozzle through another fitting. The thermocouple in this case could be run through the 12 inch tube to the nozzle inlet to monitor the temperature of the gas stream as it enters the nozzle.

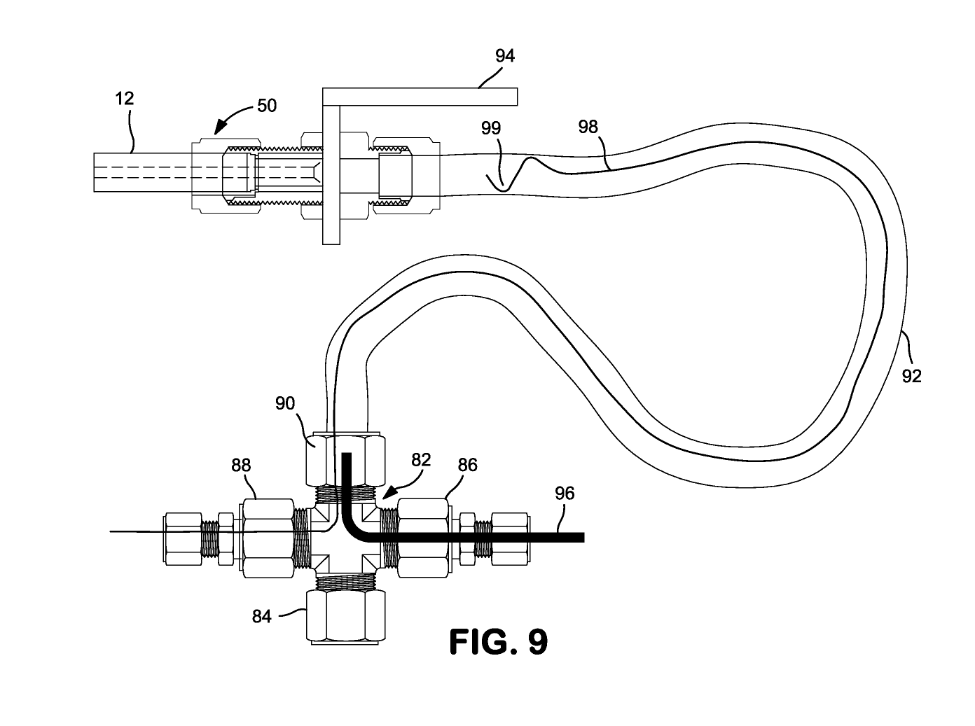

FIG. 9 shows a configuration similar to that described above, having a four way fitting 82 having one connection 84 for a hot gas inlet, one connection 86 for powder injection, one connection 88 for introducing a thermocouple and one connection 90 which can be connected to a flexible conduit 92. This flexible conduit 92 can then be connected through a further fitting or assembly 50 to nozzle 12. This portion of the device can also be connected to a robot through a mount 94 which can be used to control and position nozzle 12 as desired.

As shown, powder injection can be used through a tube 96 which can be bent into alignment with connection 90 and conduit 92 as shown. Further, thermocouple 98 can be threaded into connection 88 and out of connection 90 and along conduit 92. By positioning a bend 99 near the end of the thermocouple, the tip of the thermocouple can be aligned in the center of the tube for proper gas temperature measurement.

In the configuration illustrated in FIG. 9, the powder is carried along with hot gas through the extent of conduit 92 until it reaches nozzle 12. This would be one configuration for use in instances where this amount of heating of the powder is desirable or at least acceptable.

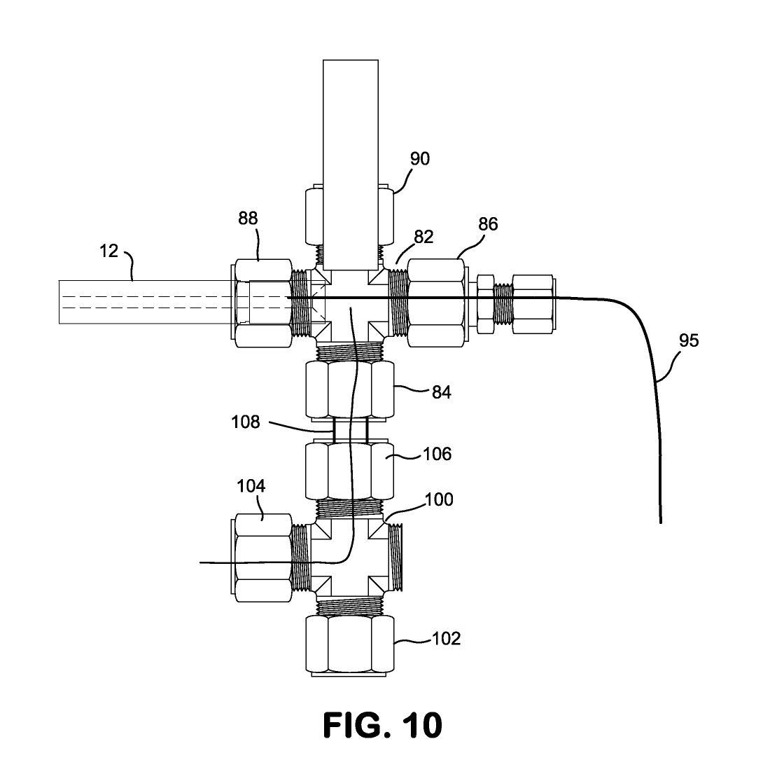

FIG. 10 shows a further configuration where two different fittings are used, namely, a four-way fitting 82 and an additional fitting 100. Fitting 100 can have one connection 102 for hot gas and a second connection 104 for the thermocouple. A third connection 106 can be provided for connecting to a short conduit 108 which leads to four-way fitting 82. Four-way fitting 82 can have connection 84 for connecting to tube 108 such that connection 80 receives both hot gas and the thermocouple. Connection 86 can be used to receive a powder injection, connection 88 can be used to connect to nozzle 12 and connection 90 can be used to connect to a robot.

In the illustrated configuration, it should be noted that the powder injection tube 95 extends through connection 86 and a central portion of four-way fitting 82 through connection 88 and into or through the throat section of nozzle 12. This aspect is not illustrated in great detail in FIG. 10, but could be as illustrated in FIG. 6 showing a powder injection conduit extending through a throat of the nozzle. In this configuration, a very compact assembly is provided with very little pre-heating of the powder, and this can be desirable to avoid problems with respect to the powder sticking to inner surfaces of the nozzle. It should also be noted that conduit 95 for injection of powder is axially aligned with nozzle 12, and introduces the flow substantially along the axis of nozzle 12.

One or more embodiments of the present disclosure have been described. Nevertheless, it will be understood that various modifications may be made without departing from the spirit and scope of the disclosure.

What is claimed is:

1. A cold spray nozzle assembly, comprising:
a conduit for carrying at least one of a heated gas and a powder;
a nozzle; and
a compression tube fitting connecting the nozzle to the conduit.

2. The assembly of claim 1, wherein the compression tube fitting comprises a receiving fitting attached to the conduit and receiving an end of the nozzle, a compression ring and a compression nut, the compression ring being mounted between the receiving fitting and the compression nut and surrounding the nozzle, whereby tightening the compression nut onto the receiving fitting compresses the compression ring onto the nozzle.

3. The assembly of claim 1, further comprising a step on an outer diameter of the nozzle, the step interacting with the receiving fitting to properly locate the nozzle to the receiving fitting.

4. The assembly of claim 1, wherein the nozzle has a notch
on an outer diameter which is aligned with the compression ring whereby the compression ring engages the notch when the compression nut is tightened relative to the receiving fitting.

5. The assembly of claim 1, wherein the receiving fitting
is threaded to the conduit.

6. The assembly of claim 1, wherein the nozzle has a throat section, and an inlet end and an outlet end and further comprising an inlet for feeding the powder to the nozzle wherein the inlet comprises a tube for carrying the powder, the tube extending along an axis of the nozzle from the inlet end and through the throat section.

7. The assembly of claim 1, wherein the nozzle has an inlet end and wherein the inlet end has rounded edges.

8. A cold spray nozzle assembly, comprising a nozzle, having an inlet end, an outlet end and a throat section between the inlet end and the outlet end;
a conduit for carrying a heated gas to the inlet end of the nozzle;
an inlet for feeding powder to the nozzle, wherein the
inlet comprises a tube for carrying the powder, the tube extending along an axis of the nozzle from the inlet end and through the throat section.

9. The apparatus of claim 8, wherein the compression tube
fitting comprises a receiving fitting attached to the conduit and receiving an end of the nozzle, a compression ring and a compression nut, the compression ring being mounted between the receiving fitting and the compression nut and surrounding the nozzle, whereby tightening the compression nut onto the receiving fitting compresses the compression ring onto the nozzle.

10. The apparatus of claim 8, further comprising a step on
an outer diameter of the nozzle, the step interacting with the receiving fitting to properly locate the nozzle to the receiving fitting.

11. The apparatus of claim 8, the nozzle has an inlet end and wherein the inlet end has rounded edges.

12. The apparatus of claim 8, wherein the receiving fitting is threaded to the conduit.

13. The apparatus of claim 8, wherein the nozzle has a an inlet end and an outlet end and a throat section, and further comprising an inlet for feeding the powder to the nozzle wherein the inlet comprises a tube for carrying the powder, the tube extending along an axis of the nozzle from the inlet end and through the throat section.

14. A cold spray gun according to claim 8, wherein the nozzle has an inlet end and wherein the inlet end has rounded edges.

15. A cold spray gun, comprising:
a conduit communicated with a source of gas and a source of powder;
a nozzle; and
a compression tube fitting connecting the nozzle to the conduit.

16. The assembly of claim 15, further comprising a compression tube fitting connecting the nozzle to the conduit.

17. The assembly of claim 15, wherein the compression tube
fitting comprises a receiving fitting attached to the conduit and receiving an end of the nozzle, a compression ring and a compression nut, the compression ring being mounted between the receiving fitting and the compression nut and surrounding the nozzle, whereby tightening the compression nut onto the receiving fitting compresses the compression ring onto the nozzle.
